(19) United States
(12) Patent Application Publication
(10) Pub. No.: US 2007/0029807 A1
(43) Pub. Date: Feb. 8, 2007

(54) Methods and systems for generating wind energy

(76) Inventor: Clayton Kass, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/404,229

(22) Filed: Apr. 14, 2006

Related U.S. Application Data
(60) Provisional application No. 60/706,256, filed on Aug. 8, 2005.

(51) Int. Cl. F03D 9/00

(52) U.S. Cl. 290/55

(57) ABSTRACT

The present disclosure disclosures methods and systems for harnessing wind to create electricity. The present disclosure discloses a helical blade vertical axis wind generator. One or more blades are spun by the force of wind which in turn spins a generator and produces electricity.

### PRIORITY CLAIM TO RELATED PROVISIONAL APPLICATION

The present application claims priority benefit under 35 U.S.C. § 119(e) to U.S. Provisional Patent Application Ser. No. 60/706,256, filed Aug. 8, 2005, entitled “Wind Tower System.” The present application incorporates the foregoing disclosures herein by reference.

### FIELD OF THE DISCLOSURE

The present disclosure relates to the field of electricity production. More specifically the present disclosure relates to producing electricity by harnessing wind.

### BACKGROUND

Electricity has become a staple in modern society. People depend on having a constant source of electricity in all facets of their lives. Electricity powers business, provides convenience, and saves lives. There is an ever growing demand for electricity. Unfortunately, generating electricity can be expensive and damaging to the environment. Cleaner and more efficient sources are needed to supply society's ever growing demand for electricity.

One method of generating electricity harnesses wind to spin a generator. Current methods of harnessing wind to generate electricity include propeller-style horizontal wind generators that range from 1-300 feet high. Large wind generating machines include a nacelle which houses the generator, gears, motors, control, and braking systems. The nacelle is placed in a horizontal configuration such that the axis of the shaft rotated by the wind generator's blades is horizontal. The nacelle of current wind generators are placed on top of a high tower to allow for blade rotation. In order to maintain the wind generator, a technician climbs to the top of the tower, which can be up to and higher than 300 feet in the air. Because of the height, it can be difficult and expensive to maintain the various operating components of the wind generator. In addition, the blades and nacelle in a horizontally configured wind generator rotate to face the wind direction. Rotation to face wind direction generally includes use of a motor which consumes electricity, lowering the overall efficiency of the wind generator and adding to the cost of the generator. A starter motor is also often used to begin electricity production, again potentially lowering efficiency and adding to the cost of the generator. Another drawback of some wind generators is that they generally do not operate at wind speeds less than about 18 mph or higher than about 35 mph.

### SUMMARY OF THE DISCLOSURE

Aspects of the present disclosure include methods and systems for harnessing wind to create electricity. The present disclosure includes a vertical oriented wind generator system. One or more blades are spun by the force of wind which in turn spins a generator to produce electricity. In an embodiment, the blades are generally helical. Because of its vertical configuration, the blades are capable of operating at lower and higher wind speeds. Moreover, vertical configuration allows the nacelle to be placed closer to the ground, which allows for easier access and lower maintenance costs. In addition, the blades face the wind from all directions. In an embodiment, the blades begin rotation without a starter motor.

In an embodiment, a high electrical output vertically configured wind generator is disclosed. The wind generator comprises a generally vertical axis shaft, at least one blade operably connected to the shaft, a braking system operably connected to the shaft, and a generator operably connected to the shaft.

In an embodiment, the wind generator utilizes a kinetic energy storage system operably connected to the shaft in order to store and release kinetic energy. In an embodiment, the wind generator has an electricity storage system for storing generated electricity. In an embodiment, the wind generator is gearless.

In an embodiment, the wind generator has a flushing member. In an embodiment the flushing member has one or more openings. In an embodiment, the one or more openings have retractable closing members. In an embodiment, the flushing member is moveable along an axis of the shaft. In an embodiment, the flushing member is located below the blades. In an embodiment, the flushing member is located above the blades.

In an embodiment, the blades are helical. In an embodiment, the blades comprise a single blade. In an embodiment, the blades comprise two blades. In an embodiment, the blades comprise three or more blades. In an embodiment, the blades comprise a first cross-sectional width which is greater than a second cross sectional width.

In an embodiment, the generator can operate in wind speeds of between about 8 mph and about 75 mph. In an embodiment, the wind generator can operate in wind speeds of between 12 mph and 75 mph. In an embodiment, the wind generator can operate in wind speeds of between 8 and 60 mph. In an embodiment, the wind generator can operate in wind speeds of between 12 and 45 mph.

In an embodiment, a vertical wind generator is disclosed. The vertical wind generator comprises a blade rotated by wind, a vertical shaft connected to the blade, and a generator operably connected to the shaft, wherein the blade is capable of being rotated by wind with sufficient force to produce 1.5 MW or more of power. In an embodiment, the blade is capable of being rotated by wind with sufficient force to produce 1 MW or more of power. In an embodiment, the blade is capable of being rotated by wind with sufficient force to produce 500 kW or more of power. In an embodiment, the blade is capable of being rotated by wind with sufficient force to produce 300 kW or more of power. In an embodiment, the blade is capable of being rotated by wind with sufficient force to produce 30 kW or more of power.

In an embodiment, the generator is gearless. In an embodiment, the vertical wind generator further comprises a kinetic energy storage system. In an embodiment, the vertical wind generator comprises a flushing member.

In an embodiment, a method of building blades for a wind generator is disclosed. The method comprises molding a blade from composite materials. In an embodiment, the method further comprises molding the blade in sections and connecting the sections together to form a larger blade. In an embodiment, the composite material comprises a light weight carbon fiber. In an embodiment, the composite material comprises an epoxy composite. In an embodiment, the composite material comprises reinforced plastic resonance system blocks. In an embodiment, the step of molding comprises using a vacuum infused carbon fiber system. In an embodiment, the step of molding comprises using a carbon black system.

### BRIEF DESCRIPTION OF THE DRAWINGS

The drawings and the associated descriptions are provided to illustrate embodiments of the disclosure and not to limit the scope of the claims.

FIG. 1 illustrates an embodiment of a vertical wind generator system.

FIG. 1A illustrates an embodiment of a vertical wind generator system with tube supports.

FIG. 1B illustrates an embodiment of a vertical wind generator with a tower support.

FIG. 1C illustrates an embodiment of a tower support.

FIG. 2A illustrates an embodiment of an approximate trapezoidal blade shape.

FIG. 2B illustrates an embodiment of an approximate rectangular blade shape.

FIG. 2C illustrates an embodiment of an approximate upside down trapezoidal blade shape.

FIG. 2D illustrates an embodiment of an approximate hexagonal blade shape.

FIG. 3 illustrates blade wrap.

FIG. 4 illustrates several embodiments of blade curvature.

FIGS. 5A-5E illustrate various embodiments of blades.

FIG. 6 illustrates an embodiment of a blade system with three blades.

FIG. 6A illustrates a cross sectional view of an embodiment of a blade system with three blades.

FIG. 6B illustrates a cross sectional view of an embodiment of a blade system with two blades.

FIG. 7A illustrates an embodiment of a blade system constructed from a plurality of blade sections.

FIG. 7B illustrates an embodiment of a blade section with channels.

FIG. 7C illustrates an embodiment of a blade section with pins.

FIG. 7D-7F illustrate embodiments of blade sections.

FIG. 8A illustrates an embodiment of a blade system with flushing plates.

FIG. 8B-8C illustrate embodiments of a blade system with configurable blade curvature.

FIG. 9 illustrates an embodiment of the components housed in a nacelle.

FIG. 10-10A illustrates an embodiment of a kinetic system.

FIG. 11 illustrates an embodiment of a friction clamping clutch system.

### DETAILED DESCRIPTION

Embodiments of the present disclosure include a vertically oriented wind energy generator. The wind generator harnesses wind to generate electricity. Structural components are chosen to minimize wind blockage. Blade configurations are chosen to maximize blade efficiency by increasing wind harness and decreasing drag. Other components, such a nacelle, generator, kinetic system, braking system, and electrical storage system are chosen to minimize setup and maintenance costs while maximizing generator output. Although disclosed with respect to certain embodiments, an artisan will recognize from the present disclosure many ways of accomplishing the concepts disclosed herein. For example, in one embodiment, the wind generator stands between about 18 and about 300 feet in height and the size of the blades can range from about 5 feet to about 260 feet and higher. In an embodiment, the wind generator is about 100 feet tall and has blades that are about 60 feet tall. In another embodiment, the wind generator is about 150 feet tall and has blades that are about 110 feet tall. In an embodiment, the wind generator is about 20 feet tall and the blades are also about 20 feet tall.

In an embodiment, the blades are helical in shape and oriented on a vertical axis. In an embodiment, a single blade is employed. In an embodiment, multiple blades are employed. In an embodiment, a nacelle is vertically oriented. In an embodiment, the wind generator operates without gears. In an embodiment, the wind generator comprises a kinetic rotation system to store and release kinetic energy. In an embodiment, blade angles are dynamically changeable.

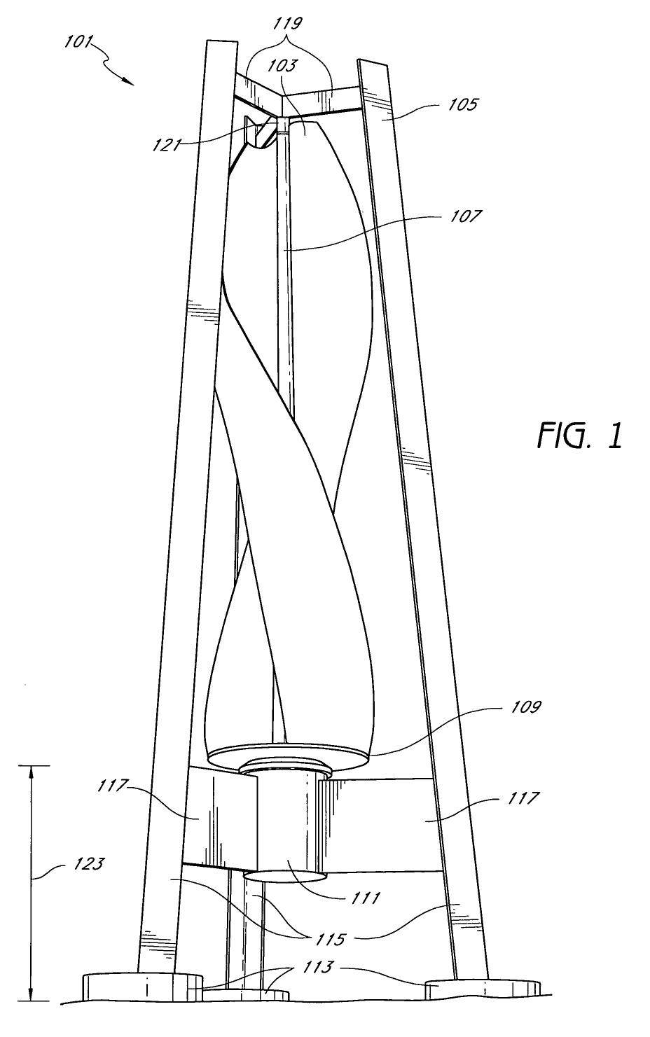

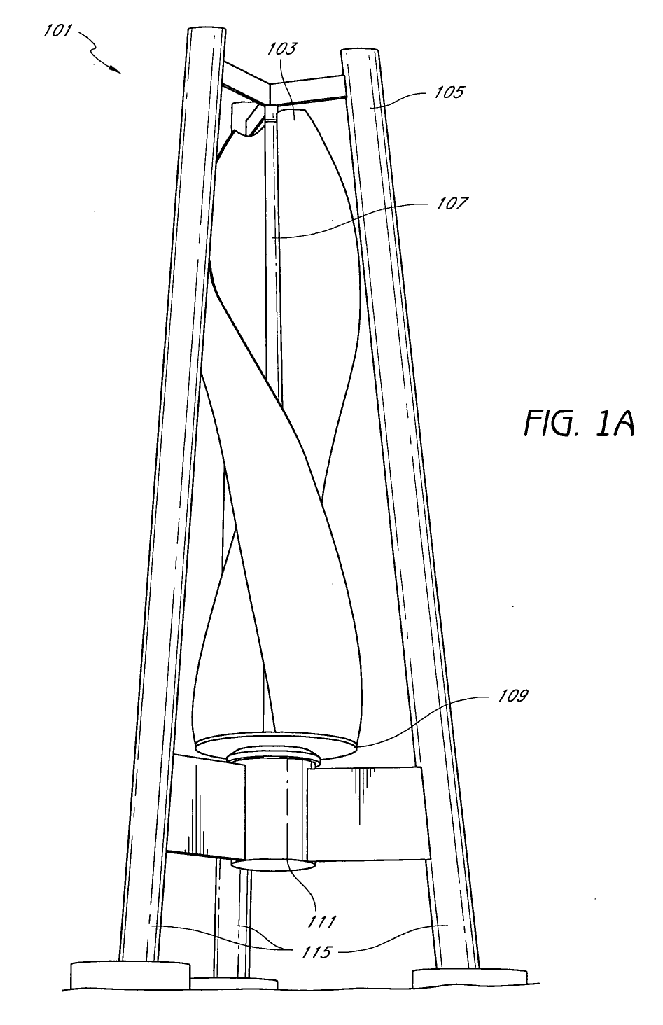

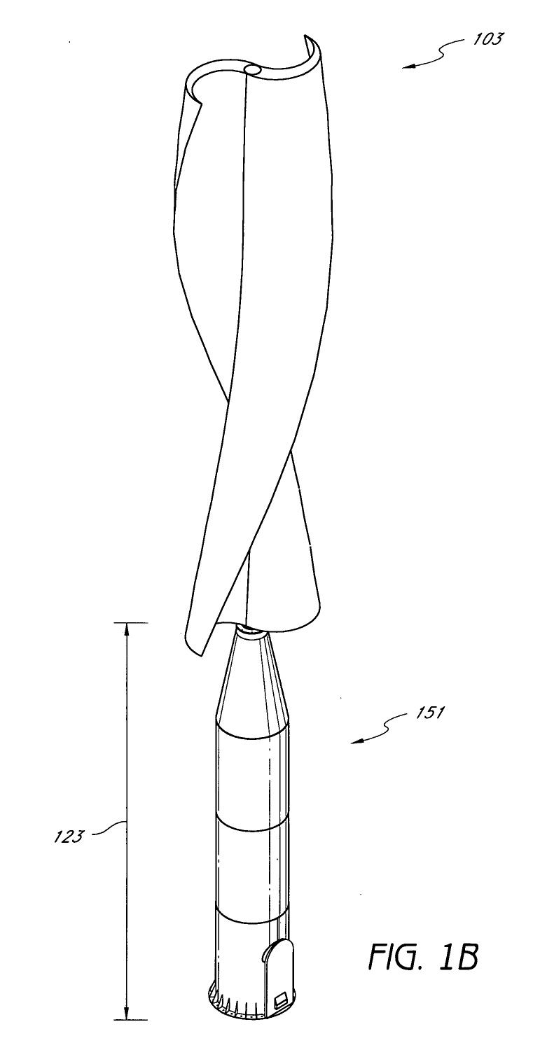

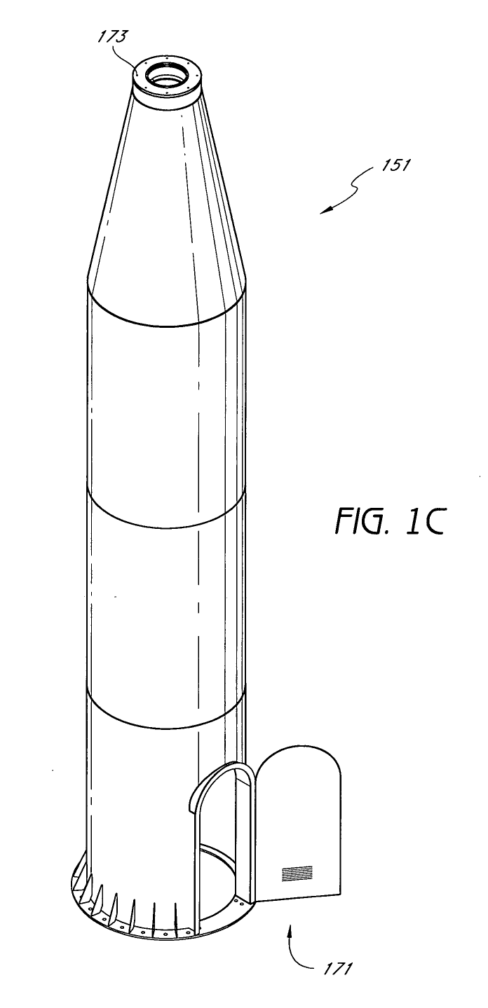

FIG. 1 illustrates an embodiment of a vertically oriented wind generator 101. As shown in FIG. 1, the vertically oriented wind generator includes blades 103, support structure 105, shaft 107, flushing plate 109, and nacelle 111. Support structure 105 supports some or all of the rest of the generator structure. Blades 103 are operably attached to shaft 107. Shaft 107 is operably connected to support 105 so that shaft 107 can spin on its axis. Shaft 107 extends into nacelle 111 and is operably attached to a generator, shown in this embodiment inside of nacelle 111. Shaft 107 may be hollow or solid. In operation, the generator is responsive to the shaft 107. The shaft 107 is responsive to the blades 103. The blades 103 are responsive to the wind. The electricity generated by the generator is then temporarily stored and sent out in energy packets, or is immediately sent out as electricity to be sold to consumers.

Support Structures

As shown in FIG. 1, one embodiment of a support 105 is a tripod support structure. Three ground supports 113 are located on and/or in the ground to provide a base. In an embodiment, structure supports 115 are attached to ground supports 113. In an embodiment, support beams 115 are slightly angled so that the support beams 115 are farther apart from each other near the ground supports 113 than they are near the top of the blades 103. Cross beams 117 connect the structure supports 115 to the nacelle 111. Cross beams 119 connect to each other and support the top of the shaft 107. Shaft support 121 supports the top of the shaft 107, allowing shaft 107 to spin freely.

Support 105 may be of various sizes, shapes, designs, and materials. In an embodiment, for example, the embodiment of FIG. 1, the structure supports 115 are angled beams which minimize wind blockage. FIG. 1A illustrates an embodiment in which supports 115 are tubes or cylinders. The tubes can be hollow or solid. Supports 115 can be angled to create a tripod structure, or they can be vertical. In an embodiment, the support structure is an H beam structure. In an embodiment, the support structure is a lattice frame structure.

In an embodiment, a single support tower is used to support the wind generator. An illustration of one embodiment of a support tower is shown in FIG. 1B. Support tower 151 supports shaft 107 and blades 103. Support tower 151 also incorporates nacelle 111. Thus, support tower 151 is also a nacelle for housing nacelle components such as a generator. As shown in FIG. 1C, support tower 151 has a door structure 171 at its base, for allowing access to the support tower 151 and nacelle components. Support tower 151 also has a shaft opening 173 for allowing the shaft to enter in and extend at least part way through the support tower. The support tower can have stairs or other access systems inside for providing access to the nacelle components. In an embodiment, the shaft extends through the entirety of the support tower 151 and further extends into the ground beneath the support tower 151.

Structural supports, such as structure support 115, provide a base to support the blades 103. The blades are suspended off the ground by the structural supports in order to place them in the best position to be spun by the wind. In an embodiment, the structural supports support the blades so that the edges of the blades 103 closest to the ground are between about 0 and 150 feet in the air. In an embodiment, the edges of the blades 103 closest to the ground are about 40 feet in the air. In an embodiment, the edges of the blades 103 closest to the ground are about 20 feet in the air. In an embodiment, the edges of the blades 103 closest to the ground are about 60 feet in the air. In an embodiment, the nacelle is located between the blades and the ground. This allows the nacelle to be close to the ground for ease in maintenance.

Structural supports are provided for supporting the blades while reducing wind blockage. An artisan will recognize from the disclosure herein other structures for supporting the blades. For example, a ground system where the blades are supported near the ground can be used. In one embodiment, a concrete support structure supports the blades with the lower edge of the blades flush with the ground. In one embodiment, a solid support structure, such as a concrete block, supports the blades. Artisans will also recognize other support structures from the present disclosure.

Blade Configurations

The shape of the blades 103 affects the efficiency of the wind generator. In describing the blade shape, three separate blade descriptions are used herein. These blade descriptions are wind swept volume, wrap, and blade curvature. Wind swept volume is defined herein as the volume of air through which the blades pass in their normal course of rotation. Wrap is defined herein as how many revolutions around the shaft a single blade is rotated. Blade curvature is the amount of curvature of a given horizontal cross section of the blade.

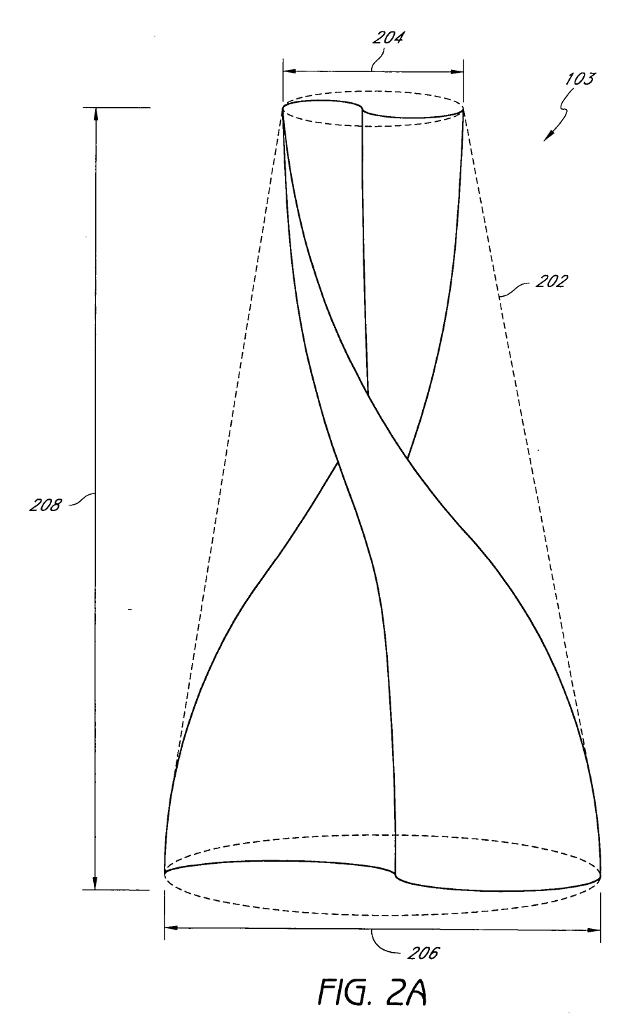

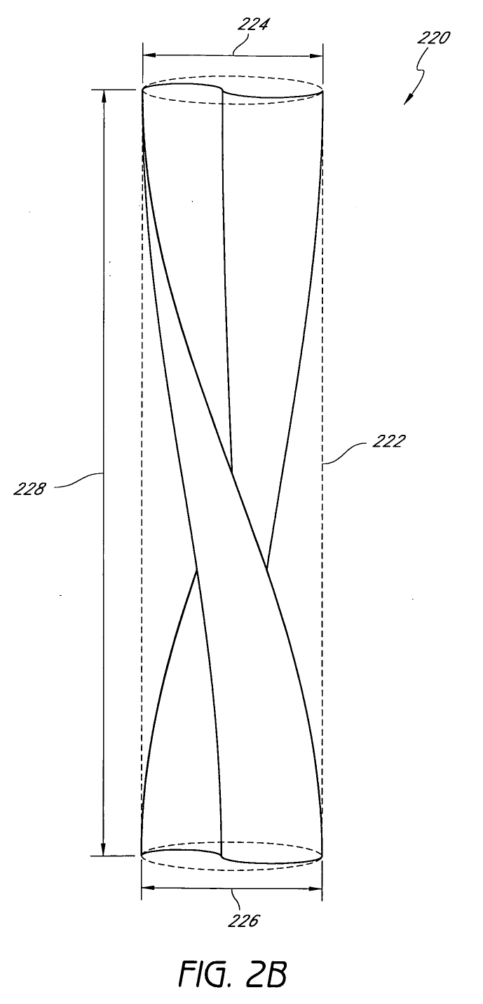

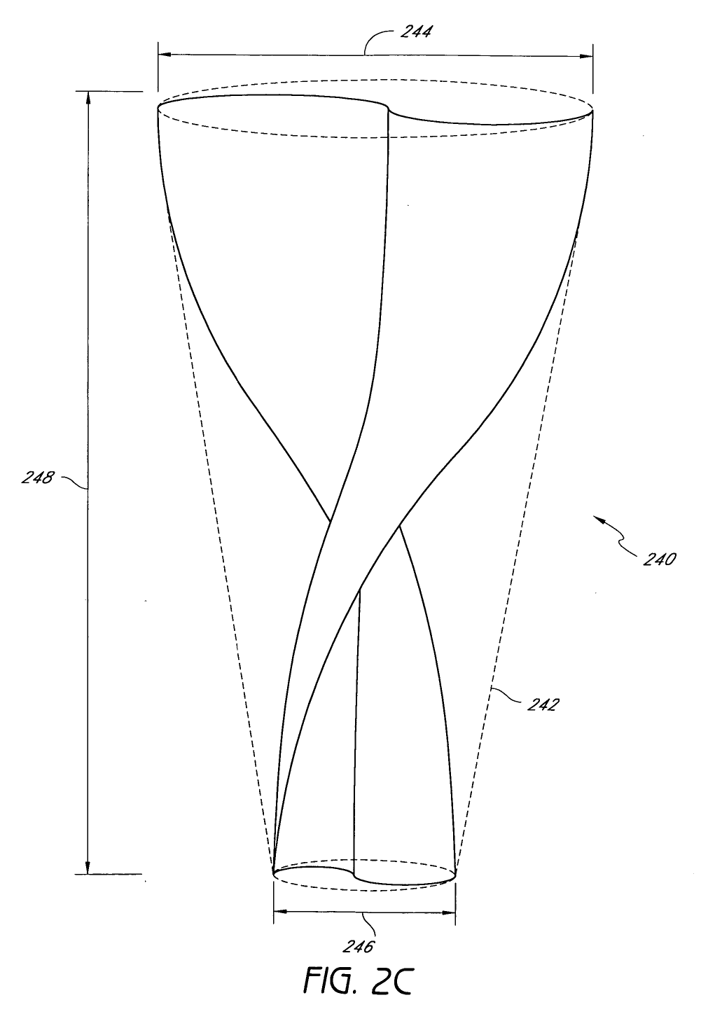

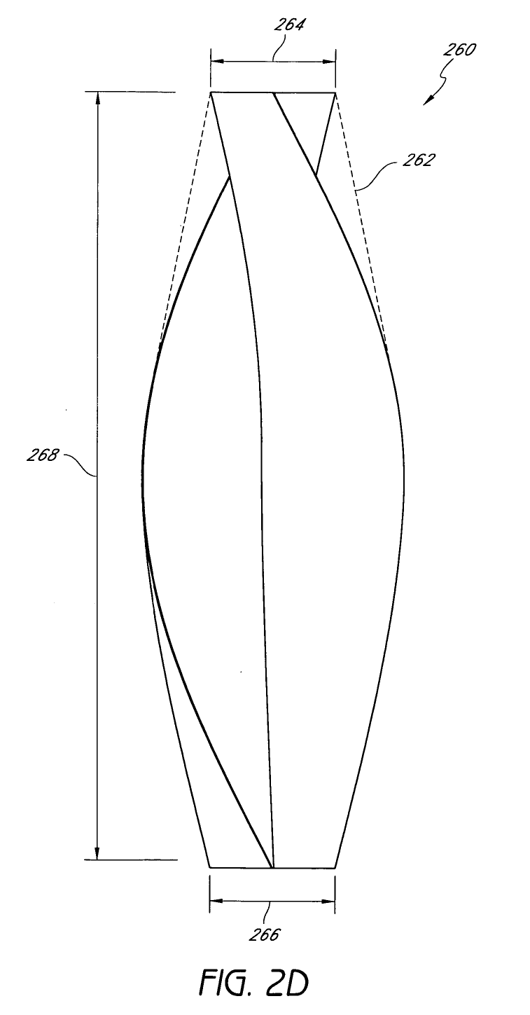

FIGS. 2A-2D illustrates examples of wind swept volume. FIG. 2A illustrates an embodiment of windswept volume 202. The shape of blades 103 passes through a windswept volume 202 which is approximately frustroconical in shape. A vertical cross section of the windswept volume 202 would have an approximately trapezoidal shape. The vertical cross section of the windswept volume can be defined by a ratio of widths. For example, in FIG. 2A blades 103 have a first width 204 and a second width 206. The blades can be defined by a ratio of a first width to a second width. In an embodiment, a ratio of the first width 204 to the second width 206 is about 1:3, in other words, the second width 206 is three times the first width 204. In an embodiment, the ratio of widths is about 1:5.

FIG. 2B illustrates an embodiment in which the wind swept volume is cylindrical. The ratio of widths of a vertical cross section of the wind swept volume is about 1:1. Blades 220 have a first width 224 and a second width 226 which are substantially equal. FIG. 2C illustrates another embodiment in which blades 240 have a wind swept volume 242 which is frustoconical in shape. The ratio of blade width 244 to blade width 246 is about 3:1. FIG. 2D illustrates an embodiment in which a blade 260 has a wind swept volume 262 of a double frustocone. In defining width ratio of the vertical cross section of the wind swept volume of a blade such as blade 260, a third width is useful. The width ratio of blade 260 is about 1:3:1, where the third width is three times the size of the first and second widths. Of course, other width ratios will work, such as, for example, about 1:4:1, about 1:5:1, about 1:3:2 or other width ratios. In one embodiment, the width ratio of the blades range from 1:1 to 1:10 or from 1:1:1 to 1:10:1. In one embodiment, the width ratio of the blades range from 1:1:1 to 1:1:10 or from 1:10:1 to 1:10:10 or from 1:1:1 to 10:1:10. Various other wind swept volumes and width ratios can be used with the present disclosure. For example, the wind swept volume may be conical or double conical. The wind swept volume can also be curved or spherical.

Generally, the shape of the vertical cross section of the wind swept volume is used to compensate for waste wind. That is, at any given altitude the wind speed may be different. At higher altitudes, the wind speed may be higher or lower than the wind speed at a lower altitude. The blades are made to be wider at areas of lower wind speed in order to pick up more of the wind than at areas of higher wind speed. An artisan will recognize from the disclosure herein that the design choice of the blade shapes can be altered depending on the location of the wind generator and the wind conditions at that location.

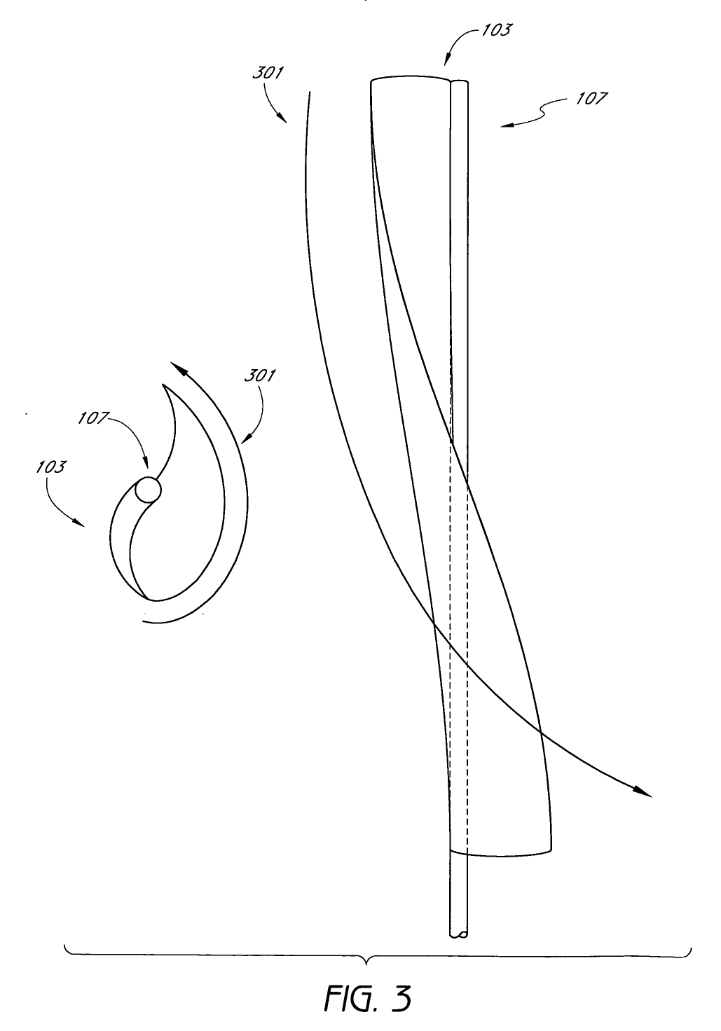

FIG. 3 illustrates the measurement of blade wrap. Blade 103 is wrapped around shaft 107. Blade wrap 301 illustrates how many revolutions around shaft 107 blade 103 is wrapped. For example, in FIG. 3, the blade wrap 301 is about 180 degrees. In an embodiment, the blades 103 have a blade wrap greater than about 1 degree. In an embodiment, the blades 103 have a blade wrap 301 of between about 1 degree and about 1080 degrees. In an embodiment, the blades have a wrap of about 90 degrees. In an embodiment, the blades have a wrap of about 270 degrees. In an embodiment, the blades have a wrap of about 360 degrees. In one embodiment, the amount of wrap is varied across the length of the shaft. For example, the blade wrap may be higher near the top or the bottom than in the middle. Blade wrap affects the dumping angle for the wind. The dumping angle affects the amount of drag on the blades. Generally, a higher wrap angle emphasizes less drag while a lower wrap angle emphasizes more force exerted on the blades by the wind. An artisan will recognize from the disclosure herein that the design choice of a higher wrap comes at the cost of a decrease in the force exerted on the blades by the wind.

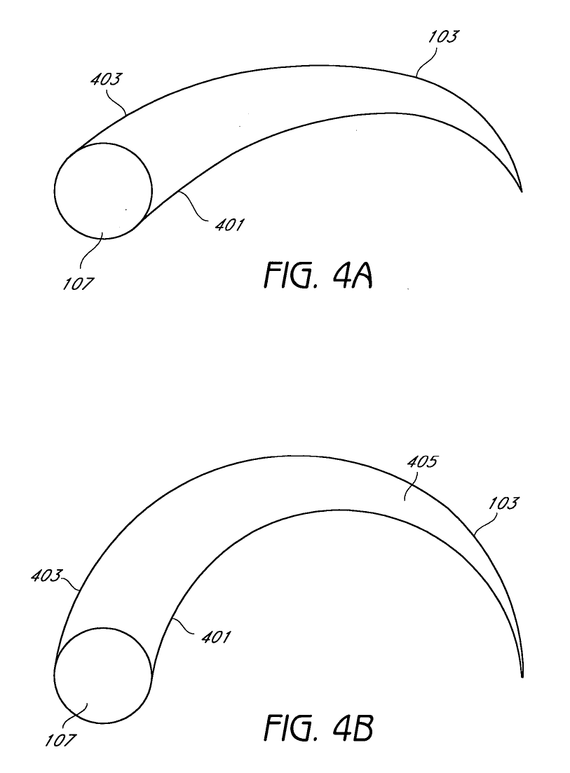

FIGS. 4A and 4B illustrate several embodiments of blade curvature. The curvature of the inner and outer blade surfaces 401, 403 can be the same or different. For example, the inner curvature 401 can be less than the outer curvature 403. In an embodiment, the curvature at any point along the inner and outer surfaces 401, 403 can be different than curvature at any other point along the same surface. In an embodiment, the curvature along each surface is uniform at any point. In an embodiment, the curvature of the blades 103 changes from the top of the blade to the bottom of the blade, or in other words, the blade curvature at any given cross section can be different than the curvature at any other cross section. Blade curvature affects how much wind the blade takes in and pushes out. Generally, the more blade curvature emphasizes more wind intake. Generally the more wind intake the higher the rotational speed. More curvature is useful for lower wind speed conditions, and lower curvature is useful for higher wind speeds. An artisan will recognize from the disclosure herein that more curvature results in a range of operable wind speeds at lower wind speeds while less curvature results in a range of operable wind speeds at higher wind speeds.

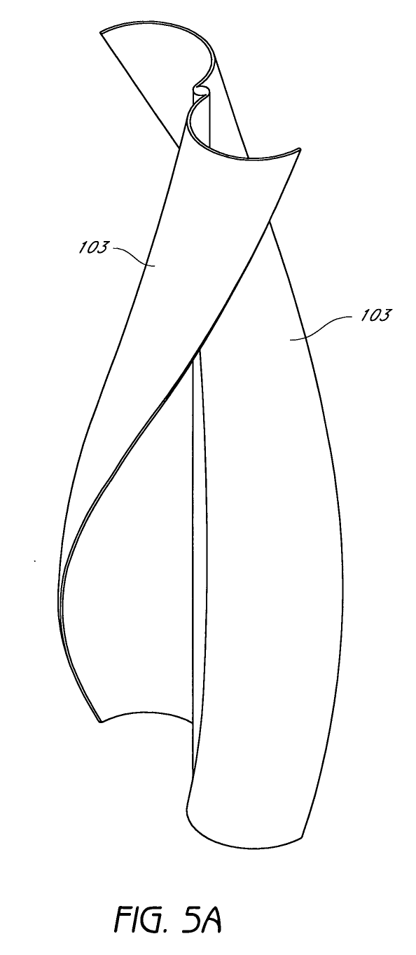

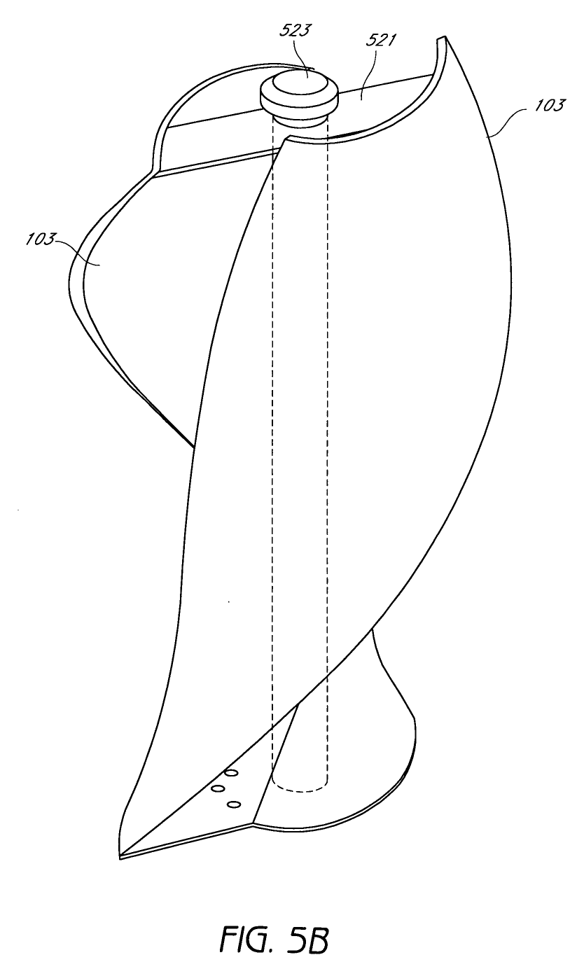

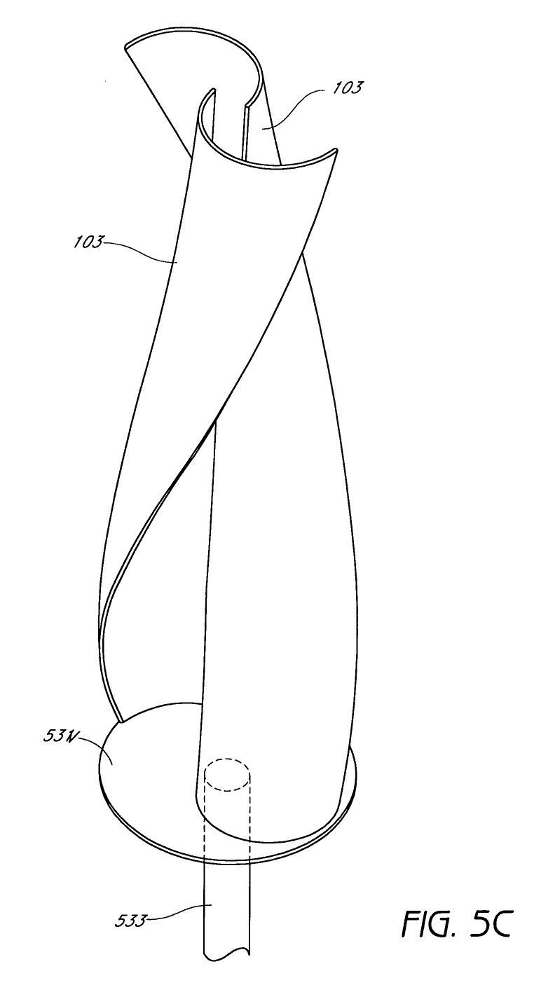

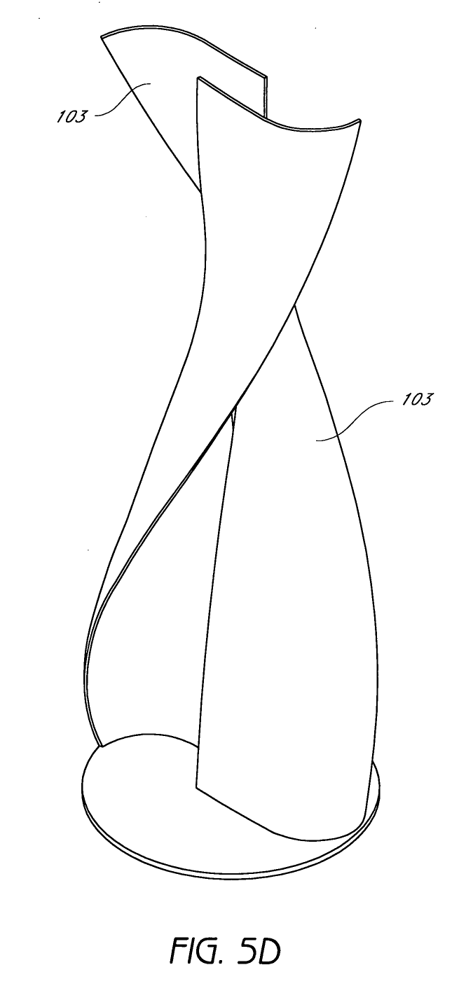

FIGS. 5A-5E illustrate various embodiments of blade configurations. FIG. 5A illustrates an embodiment in which the blade curvature is substantially the same for both the inner and outer curvature. FIG. 5B illustrates an embodiment in which blades 103 are attached to a support structure 521 instead of shaft 107. Support structure 521 is then attached to shaft 107 at shaft connector 523. FIG. 5C illustrates an embodiment in which the blades 103 are attached to a disk 531 instead of a shaft. In operation, the blades 103 are spun by the wind and in turn spin the disk 531 which spins a shaft 533 connected to the disk 531. FIGS. 5D and 5E illustrates embodiments in which the blade wrap and curvature is substantially varied throughout the blades 103.

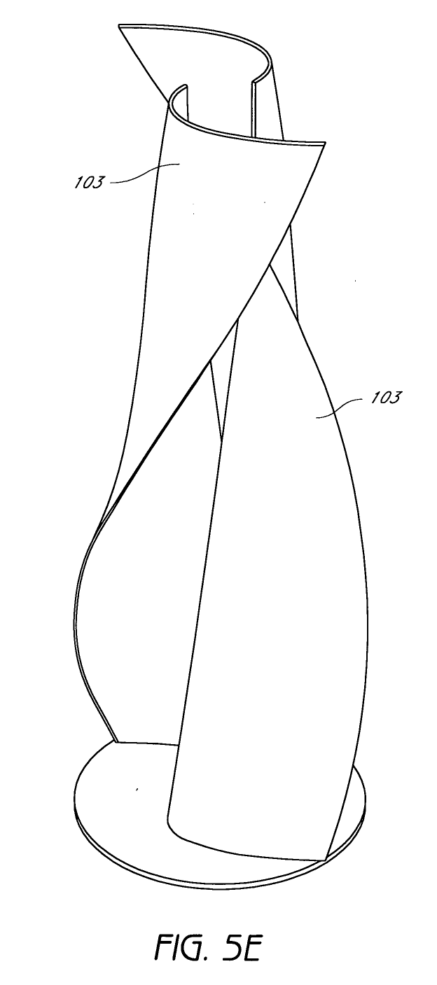

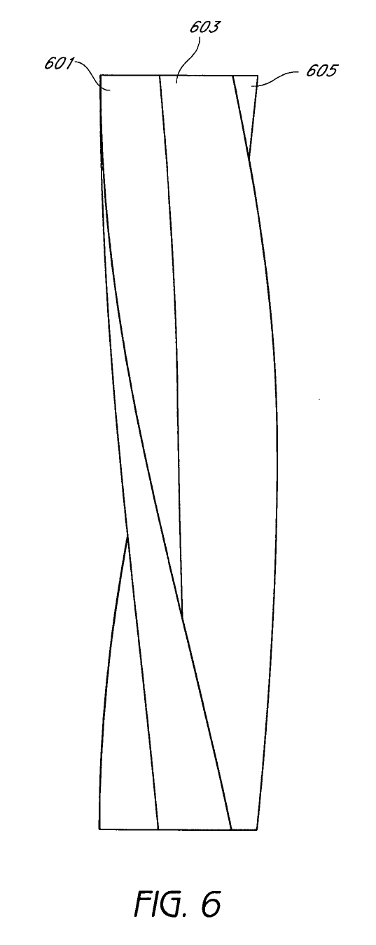

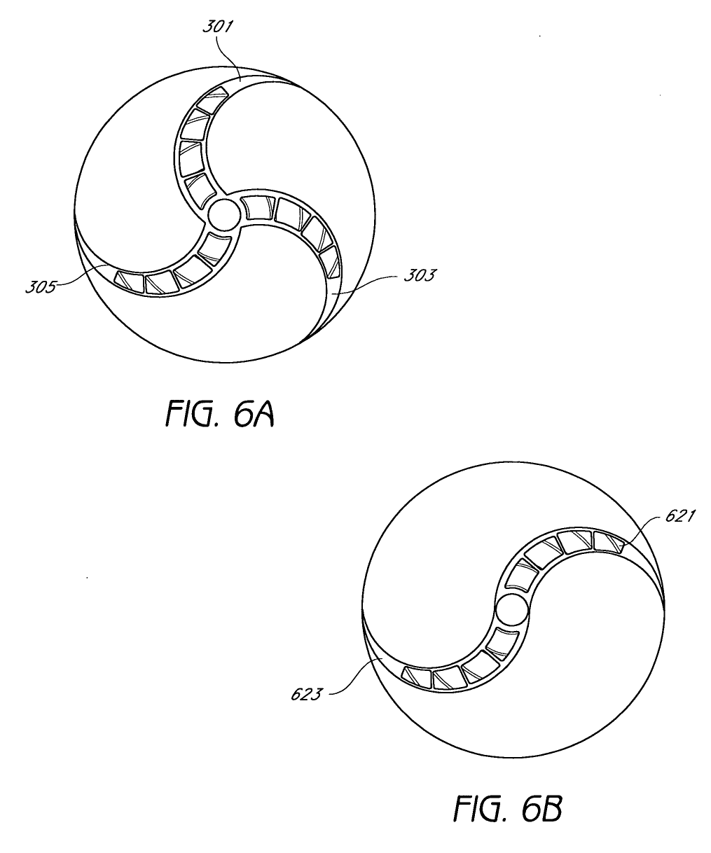

FIG. 6 illustrates an embodiment with three blades, 601, 603, 605. FIG. 6A depicts a cross sectional view of the embodiment of FIG. 6. As shown in FIG. 6A, blades 301, 303, 305 are three separate curving blades. Although three or more blades can be used with the system of the present disclosure, the more blades that are used in a single generator, the more drag is created. This is because the more blades there are, the more the blade system looks like a cylinder to the wind. The more blades there are, the greater the drag on the blades. In systems with many blades, the wind tends to go around the blades instead of pushing the blades. Thus, although system with three or more blades can be used, a single or double bladed wind generator is preferred. FIG. 6B illustrates a cross section of an embodiment of a double bladed system with two blades 621, 623. An artisan will recognize from the disclosure herein that various other embodiments of blade configurations are possible.

Material Composition/Blade Sections

In an embodiment, the blades can be made from various materials using various techniques. In an embodiment, the blades are made from a metal or metal alloy, such as, for example, lightweight aircraft aluminum. In an embodiment, the blades are made from composite materials. Composite materials are generally lighter and stronger than metals or metal alloys. In an embodiment, the blades are made from a light weight carbon fiber. In an embodiment, the blades are made using a vacuum infused carbon fiber system, such as an epoxy composite using a carbon black system. In an embodiment, the blades are made from reinforced plastic resonance system blocks. In an embodiment, the blades are made with a a light and strong fill material such as a Styrofoam core. In an embodiment, the blade has hollowed out sections. Of course, various other materials and techniques for building the blades can be used.

In an embodiment, the blades can be constructed or molded as a single piece, or the blades can be built in sections. Although the blades can be built and/or molded as a single piece, the costs associated with molding and transporting a large blade can be high. Thus, in an embodiment, the blades are constructed and/or molded as sections and then assembled together to create a single large blade.

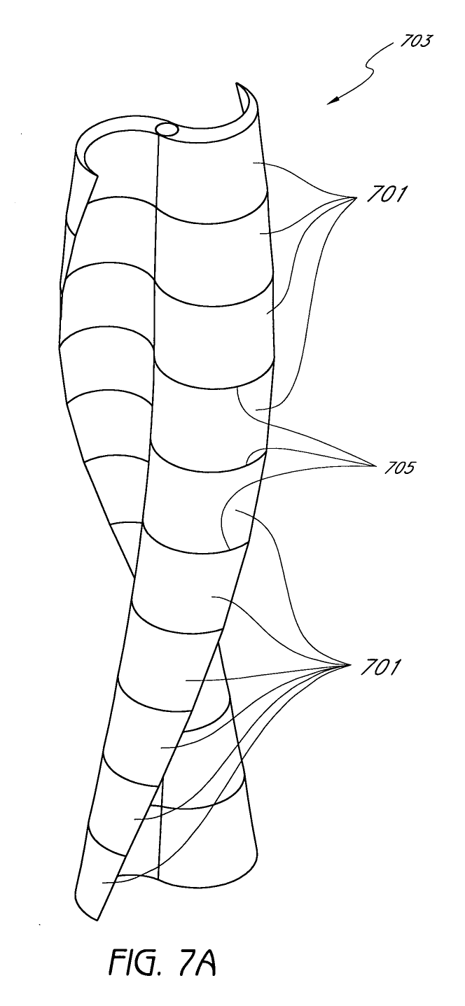

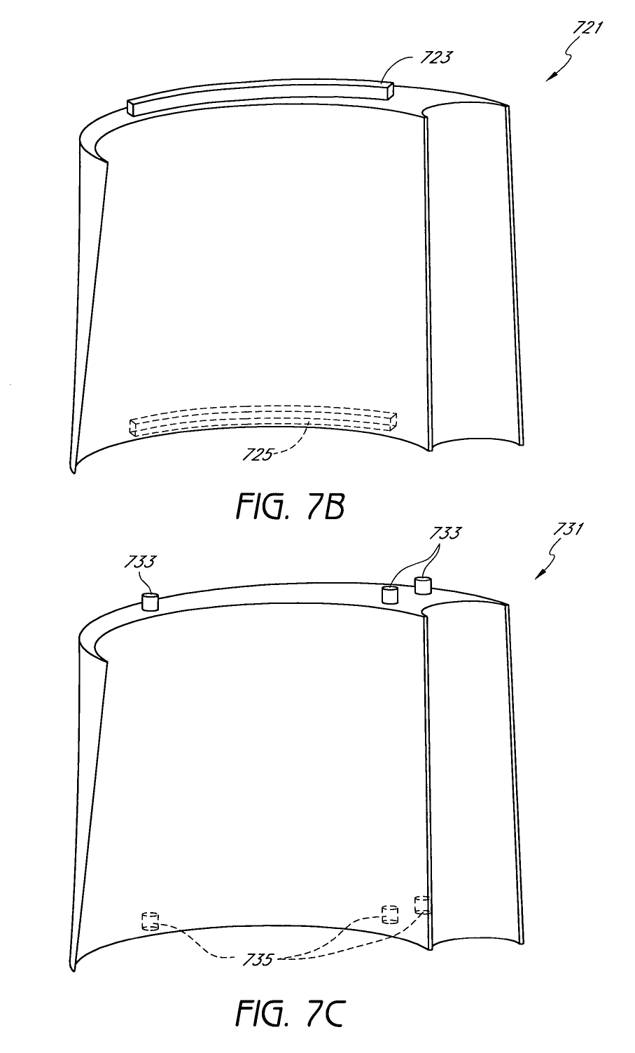

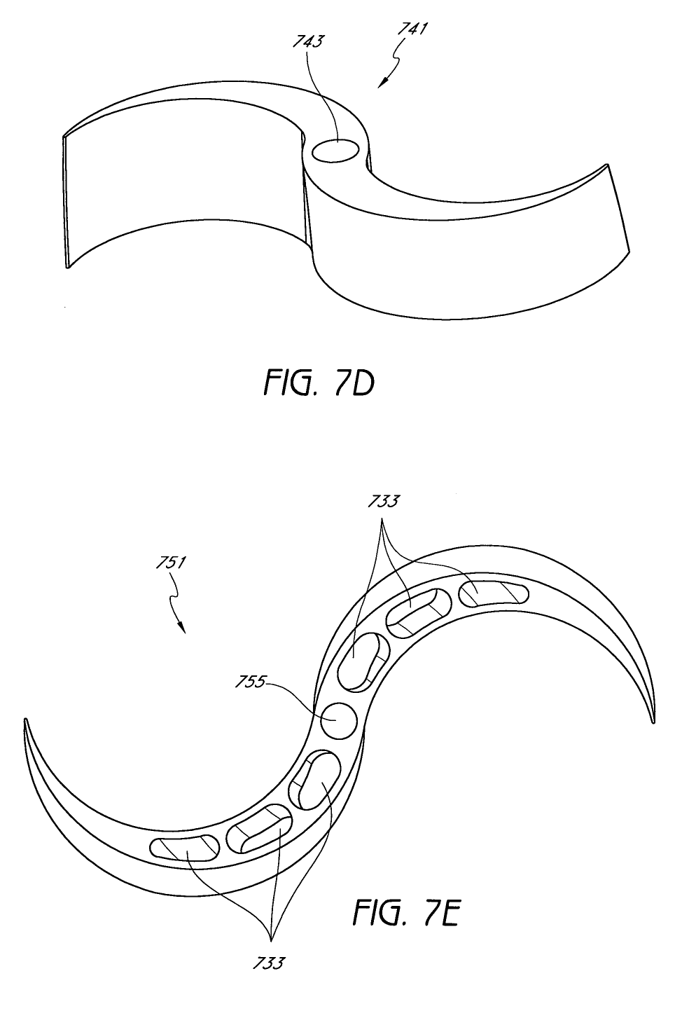

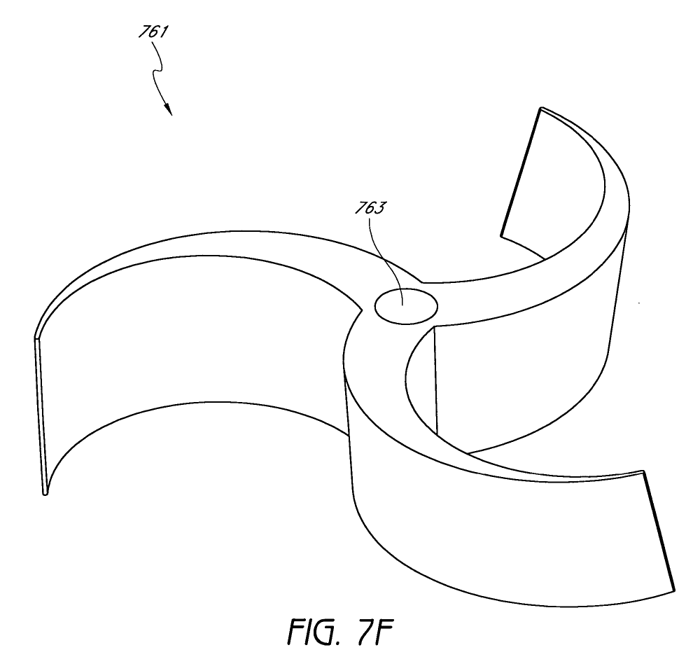

FIG. 7A illustrates an embodiment of a blade 703 which has been built from molded blade sections 701. Blade 703 has connection joints 705. The connection joints 705 can be horizontal, vertical, or any other configuration. In an embodiment, the blade sections 701 are about 6 feet tall and range from about 2 to about 10 feet wide. In an embodiment, the blade sections 701 are about 6 feet tall and range from about 2 to about 18 feet wide. In an embodiment, about 10 sections are used to form about a 60 foot blade. In an embodiment, about 18 sections are used to form about a 110 foot blade. Although described with reference to certain preferred embodiments, the dimensions of the blades and blade sections can be varied. More or fewer blade sections can be used to construct large blades. In addition, the blade section size and shape can be varied within a single blade construction. An artisan will recognize from the disclosure herein that a smaller section size can be used to reduce manufacturing and handling costs while a larger blade section is more robust and makes for a sturdier blade.

The blade sections can be connected together to form a larger blade. The sections can be held together by various methods of fastening, such as, for example, interlocking channels, pins, adhesives, straps, internal cabling, welds, screws, bolts, clamps, frictional strips, or other fasteners. FIG. 7B illustrates an embodiment in which interlocking channels 723, 725 are used to connect the blade section 721 to other blade sections. Blade section 721 has a male channel 723 and female channel 725 running along a top and bottom portion of the section 721. Other blade sections also have corresponding male and female channels. The upper most and the lower most blade sections have only either a male or female channel. FIG. 7C illustrates an embodiment in which pins are used to connect blade section 731 to other blade sections. Blade section 731 has male pins 733 and female pins 735 for connecting to other blade sections. The male pins of one section are inserted into the female pins of an adjacent section. Any and all other fastening techniques known to an artisan from the disclosure herein can be used with pins and channels. For example, in an embodiment, glue is also used in addition to pins or channels to hold the blade sections together. In an embodiment, pins, channels, and glue are all used to hold the blade sections together. Other combinations of fasteners can also be used to hold the blade sections together.

FIG. 7D illustrates an embodiment in which a blade section 741 has a section of each blade in a double blade system. Blade section 741 also has a space 743 for a shaft. FIG. 7E illustrates an embodiment in which a blade section 751 is molded with weight reducing hollow sections 753, in order to reduce the weight of the blade sections. Blade section 751 also has a space 755 for a shaft. FIG. 7F illustrates an embodiment in which a blade section 761 has a section of each blade in a triple blade system. Blade section 761 also has a space 763 for a shaft.

Blade Shaping and Flush Control

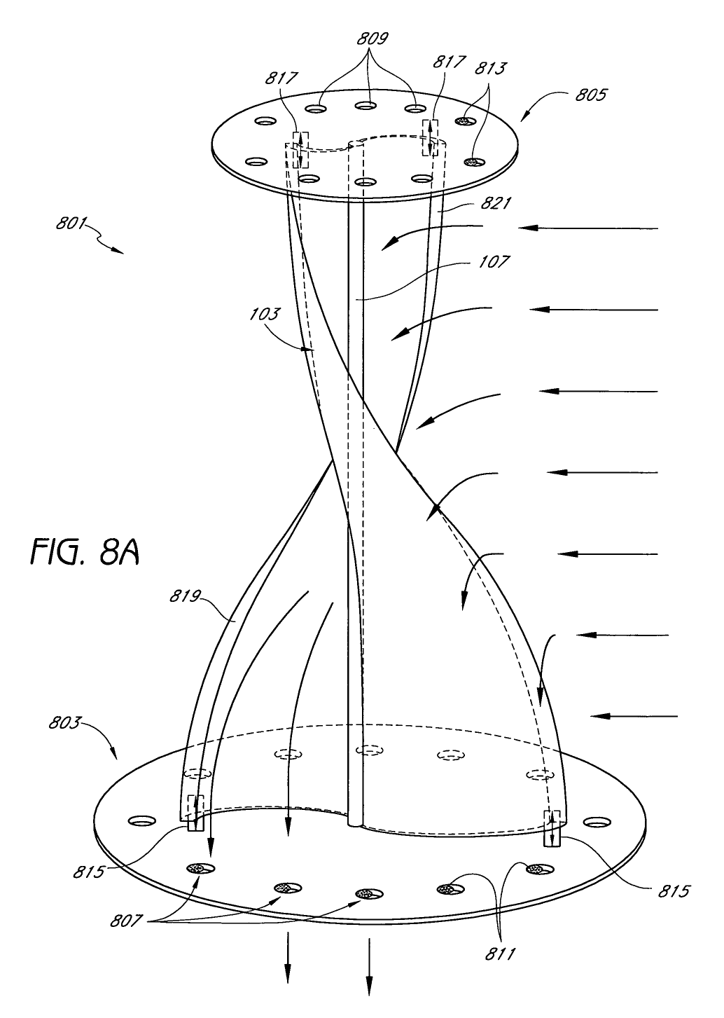

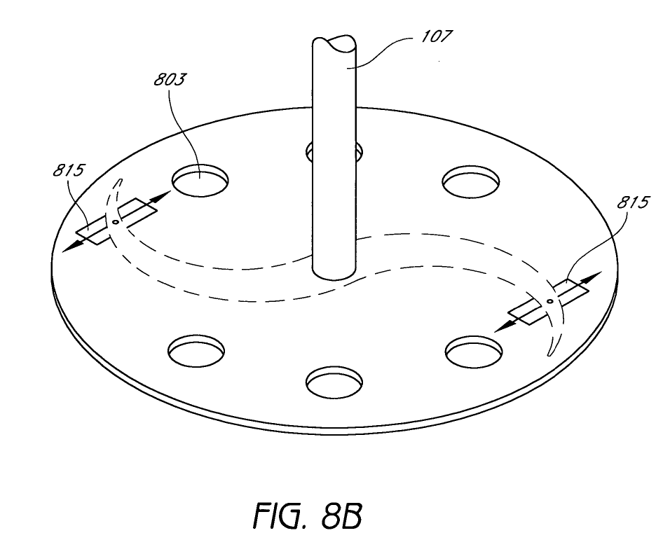

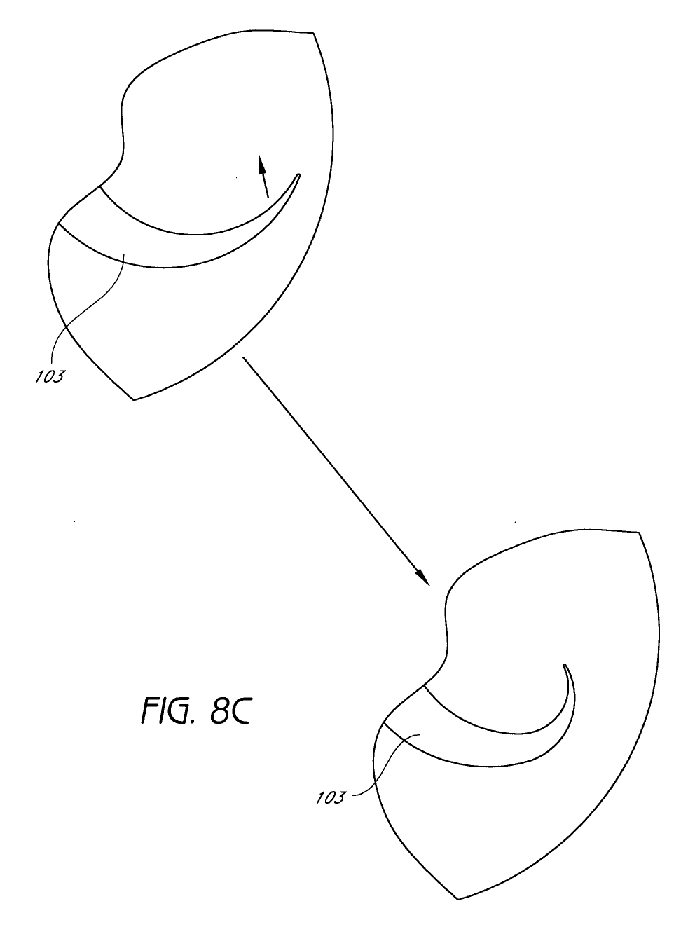

In an embodiment, a flush plate is placed at the bottom and/or top of the blades. FIG. 8A illustrates an embodiment of a blade system 801 in which flush plates 803, 805 are placed at the bottom and top of blades 103. The flush plates 803, 805 provide a system of flushing wind up or down. In an embodiment, the flush plates allow the blades 103 to be lifted slightly off the blade's bearings by the force of the wind against the flush plate so as to allow the blades to spin with less friction and stress on the bearings. In an embodiment, the flush plates 803, 805 have openings 807, 809. The openings 807, 809 have opening covers 811, 813 which open and close to increase or decrease flushing. Any number of openings 807, 809 and locations of openings 807, 809 on flushing plate 803, 805 can be used. Flushing plates 803, 805 can also be moved up or down along the axis of the shaft in order to increase or decrease blade lift. In an embodiment, the flush plate moves about 6 inches or more along the shaft axis. In an embodiment, the flush plate moves about 2 inches along the shaft axis. In an embodiment, the flush plate moves 1 inch or more along the shaft axis. In an embodiment, the flush plate moves independently of the blades. Thus the flush plate can move closer or farther from the blade. The flush plate can have a larger diameter to deflect more wind, or a smaller diameter to deflect less wind. In one embodiment, the flush plate can move the entire length of the shaft. In one embodiment the flush plates move with the blades. In one embodiment, the flush plate moves independent of the blades. In one embodiment, the flush plate moves the up or down the all or part of length of the shaft. In one embodiment, the flush plate is located along the length of the blades so as to separate the blades into an upper half and a lower half.

In addition, the flushing plates 803, 805 have blade shapers 815, 817. Blade shapers 815, 817 mechanically bend the blades 103 in order to increase or decrease blade curvature. Blade shapers 815, 817 attach to blade shaper supports 819, 821. Blade shaper supports 819, 821 are made from a more rigid material than the blades. In one embodiment, the blade shaper supports 819, 821 are made integral with the blades. In one embodiment, the blade shaper supports 819, 821 are a thicker section of the blades made from the same material as the blades. The blade shaper supports 819, 821 can be made a metal or metal allow, such as aluminum, or can be from a composite material. The blade shaper supports 819, 821 can be integral to the blades or attached to the outside of the blades. The shaping of the blades 103 allows the blades 103 to be more efficient depending on the wind conditions. FIG. 8B illustrates another view of the blade shapers 815 of FIG. 8A. FIG. 8C illustrates an example of blade curvature change in an embodiment. As the blade shaper moves in a predetermined direction, the blades are bent to have a greater curvature.

The blade shaper supports 819, 821 can run the length of the blades or a portion of the length of the blades. In one embodiment, the blade shapers are used without a flush plate. In one embodiment, the blade shapers are used independent of a flush plate. In one embodiment, the blade shapers are adjustable cross beams running the part or all of the length of the blades. An artisan will recognize from the disclosure herein other ways of dynamically shaping blades.

Nacelle Components

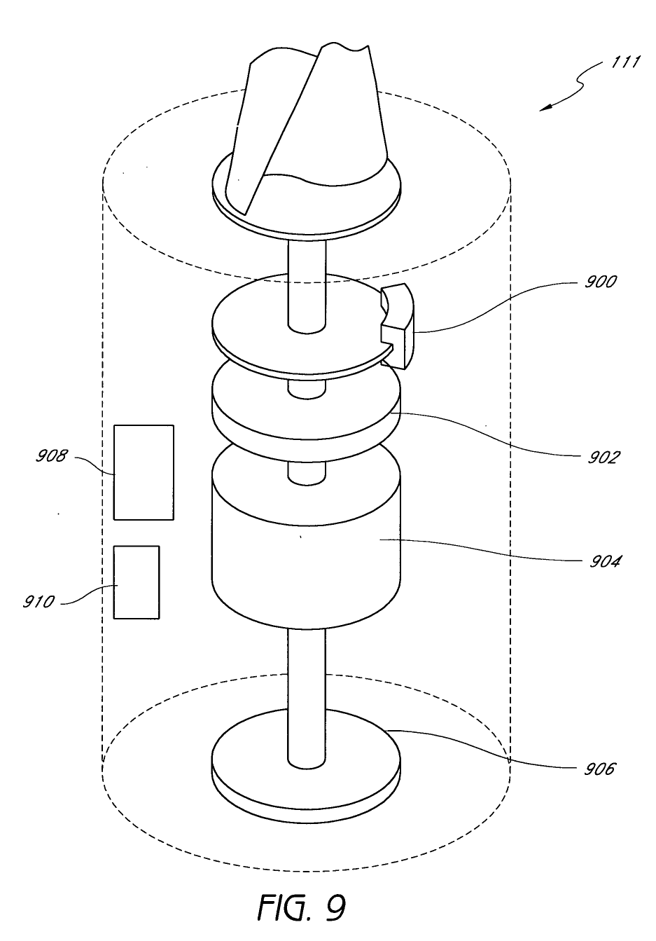

In an embodiment, the wind generator has a nacelle located around the shaft, under the blades. The nacelle can advantageously house many of the elements of the wind generator to protect them from the weather and for lowering maintenance costs. FIG. 9 illustrates an embodiment of the components housed within nacelle 111. Nacelle 111 has brakes 900, generator 902, kinetic system 904, floating bearings 906, resistor bank 908, and controls 910. The disk brakes 900, generator 902, kinetic system 904 and floating bearings 906 are all aligned with the shaft.

The system of the present disclosure can be used with or without gears. In one embodiment of a gearless system, at low speeds the generator 902 is disengaged to allow the blades to begin to spin. As the blades speed up, the generator 902 engages. At higher speeds, the generator 902 employees cut in magnets which are loaded into the generator to harness the energy created by the spinning blades. A gearless generator usable with the wind generator of the present disclosure is available from ABB of Zurich, Switzerland. In an embodiment, the generator 902 can be disengaged so that no starter motor is required. In an embodiment, a starter motor is used. In an embodiment, gears are used.

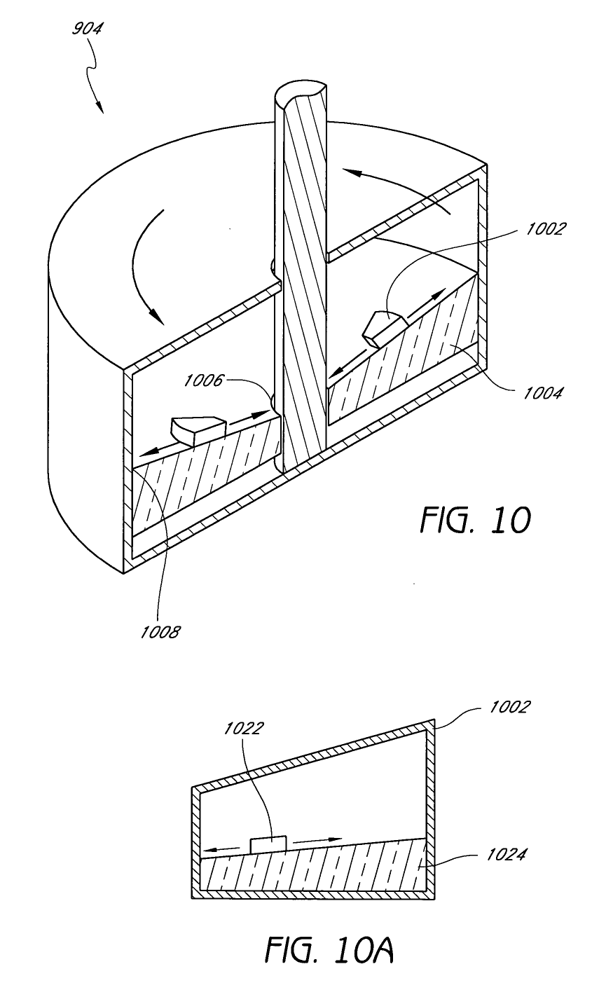

In an embodiment, the wind generator uses one or both of a kinetic and electrical storage system. In an embodiment, the wind generator uses a kinetic system 904 to store and release kinetic energy. The kinetic system 904 is especially useful when the wind speeds are erratic. The kinetic system 904 is able to store a part of the kinetic energy produced during rotation. As the wind speed decreases, the kinetic system 904 continues to rotate the shaft in order to allow the generator 902 to continue to produce electricity. FIG. 10 illustrates an embodiment of a kinetic system 904. Kinetic system 904 is attached to a section of the shaft. The kinetic system 904 has inner weights 1002 which are contained within the kinetic system housing. On the floor of the kinetic system housing is a funnel shaped ramp 1004. The ramp 1004 starts at an inner edge 1006 and goes to an outer edge 1008 of the kinetic system 1000. At the inner edge 1006, the ramp is closer to the bottom of the kinetic system housing then at the outer edge 1008. Weights 1002 are located on top of the ramp. In an embodiment, the ramp has a rise of about 0.01-99%. In an embodiment, the ramp has a rise of about 3-5%.

As the shaft begins to turn, the speed, and thus the kinetic energy is low, and the weights 1002 stay near the inner edge because they are forced by gravity to stay closest to the kinetic system floor. As the speed of the shaft, and thus the rotational speed of the kinetic system increases, the weights 1002 begin to have sufficient rotational energy to overcome the force of gravity. The weights 1002 then begin to climb the ramp toward the outer edge 1008. The movement of the weights up the ramp in effect stores kinetic energy. As the shaft slows down, the kinetic energy stored in the kinetic system 1000 is then released forcing the shaft to continue to turn. As kinetic energy is released, and the shaft begins to slow down, the weights 1002 are again forced by gravity to return to inner edge 1006. Thus, the kinetic system operates to smooth the rotational speeds of the wind generator. Other methods of storing and releasing kinetic energy may also be used. For example, in an embodiment, springs can be used instead of a ramp.

In an embodiment, the weight 1002 within the kinetic system 904 has an inner weight 1022. Also within the weight 1002 is a ramp 1024. At lower speeds, the smaller weight 1022 moves up the ramp 1024 to absorb kinetic energy in a similar manner as that described above with respect to the kinetic system 904. Thus, the weights within the weights provide for a more balanced kinetic system 904 that is able to operate at various speeds. Other embodiments of kinetic systems may also be used with the present disclosure, such as, for example, a single solid mass or a kinetic system using springs instead of a ramp.

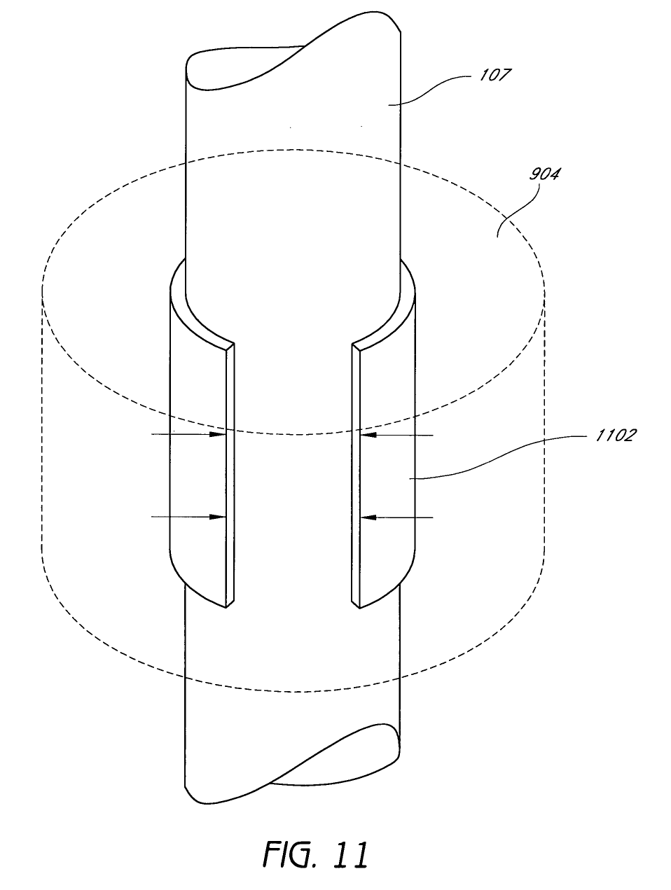

In an embodiment, the kinetic system 904 and/or the generator 902 are engageable through the use of a slip differential. This allows the kinetic system and/or the generator to be disengaged when the blades have stopped rotating, so that the blades are easier to begin to rotate. In an embodiment, the kinetic system and/or the generator are engageable through the use of friction clamps. An embodiment of friction clamps is illustrated in FIG. 11. Kinetic system 904 has friction clamps 1102 which are able to clamp onto shaft 107 while the shaft is spinning. Thus, the kinetic system and/or the generator can be effectively detached while the shaft is not rotating, in order to allow the shaft to begin rotation. When the shaft reaches a predetermined speed, the clamps 1102 close so that the kinetic system 904 and/or the generator 902 can be engaged.

In addition to kinetic energy storage, the wind generator of the present disclosure can also incorporate electrical energy storage. After the generator produces electricity, the electricity can be immediately sent out to an electrically grid, or, the electricity can be temporarily stored and sent out in packets. Temporarily storing electricity is particularly useful in low wind situations where the generator is not producing a large quantity of electricity. In an embodiment, the wind generator stores electricity in one or more capacitors. In an embodiment, the wind generator stores electricity in one or more batteries. In an embodiment, the wind generator stores electricity in one or more resistor banks.

An artisan will recognize from the disclosure herein various other alternatives parts and arrangement of parts from the present disclosure. For example, an artisan will recognize the nacelle components can be located inside or outside of the nacelle. Multiple nacelles can be used. Components can be placed on or in the ground or in the air. Nacelles can be placed on the ground or in the air. The arrangement of components along the shaft can be altered. Or, more or fewer components can be used in conjunction with the present disclosure.

Power Output and Operational Speeds

The blades of the present disclosure are capable rotating the shaft 107 with enough hoarse power to force the generator to output about 1.5 MW or more of electricity. In an embodiment, the vertical wind generator is capable of outputting about 1 MW or more. In an embodiment, the vertical wind generator is capable of outputting about 500 kW or more. In an embodiment, the vertical wind generator is capable of outputting about 30 kW or more. Because of the vertical configuration, the wind generator of the present disclosure is also capable of operating at lower and higher wind speeds than prior art generators. In an embodiment, the wind generator is capable of operating at wind speeds as low as 8 to 12 mph, and as high as 35-75 mph. The ability to operate at lower and higher wind speeds allows the wind generator of the present disclosure to produce energy more often and in a greater variety of locations because it can handle a greater range of wind speeds.

Although the foregoing invention has been described in terms of certain preferred embodiments, other embodiments will be apparent to those of ordinary skill in the art from the disclosure herein. For example, multiple independently rotated blades can be used with multiple independent shafts. Adjustable wind generator components such as the blade shapers, flush plate, gears, kinetic system, electrical storage units, and other can be manually or computer controlled to increase efficiency or other desired operating parameters. Non-electrical uses for the blade system can be used, such as, for example, harnessing the mechanical rotational force to pull water from a well, or harnessing the wind flushed to create a wind tunnel. The wind generator can be placed on a moving platform, such as a vehicle, to move the generator to another location. The blades can be rotated by wind or water. Additionally, other combinations, omissions, substitutions and modifications will be apparent to the skilled artisan in view of the disclosure herein. It is contemplated that various aspects and features of the invention described can be practiced separately, combined together, or substituted for one another, and that a variety of combination and subcombinations of the features and aspects can be made and still fall within the scope of the invention. Furthermore, the systems described above need not include all of the modules and functions described in the preferred embodiments. Accordingly, the present invention is not intended to be limited by the recitation of the preferred embodiments, but is to be defined by reference to the appended claims.

What is claimed is:

1. A high electrical output vertically configured wind generator comprising:
a generally vertical axis shaft;
one or more blades connected to the shaft;
a generator connected to the shaft; and
wherein the vertically configured wind generator includes a height greater than about 18 feet.

2. The wind generator of claim 1, further comprising a braking system connected to the shaft.

3. The wind generator of claim 1, wherein the one or more blades comprise helical blades

4. The wind generator of claim 1, further comprising a kinetic energy storage system connected to the shaft.

5. The wind generator of claim 1, wherein the generator is further configured to be gearless.

6. The wind generator of claim 1, further comprising an electricity storage system for storing generated electricity.

7. The wind generator of claim 1, further comprising a flushing member.

8. The wind generator of claim 7, wherein the flushing member further comprises one or more openings.

9. The wind generator of claim 8, wherein the one or more openings further comprise retractable closing members.

10. The wind generator of claim 7, wherein the flushing member is moveable along an axis of the shaft.

11. The wind generator of claim 7, wherein the flushing member is located below the blades.

12. The wind generator of claim 11, wherein a second flushing member is located above the blades.

13. The wind generator of claim 7, wherein the flushing member is located above the blades.

14. The wind generator of claim 1, wherein the at least one blade is helically shaped.

15. The wind generator of claim 1, wherein the at least one blade comprises a single blade.

16. The wind generator of claim 1, wherein the at least one blade comprises a two blades.

17. The wind generator of claim 1, wherein the at least one blade comprises a three or more blades.

18. The wind generator of claim 1, wherein the at least one blade comprises a first cross-sectional width which is greater than a second cross sectional width.

19. The wind generator of claim 1, wherein the generator can operate in wind speeds of between about 8 mph and about 12 mph.

20. The wind generator of claim 1, wherein the generator can operate in wind speeds of between about 40 mph and about 59 mph.

21. The wind generator of claim 1, wherein the generator can operate in wind speeds of between about 60 mph and about 75 mph.

22. The wind generator of claim 1, wherein the generator can operate in wind speeds of between about 8 mph and about 75 mph.

23. A vertical wind generator comprising:
a blade rotated by wind;
a vertical shaft coupled to the blade; and
a generator coupled to the shaft, wherein the blade produces enough horse power to rotate the shaft with sufficient hoarse power to force the generator to produce about 30 kW or more of power.

24. The vertical wind generator of claim 23, wherein the blade produces enough horse power to rotate the shaft with sufficient hoarse power to force the generator to produce about 500 kW or more of power.

25. The vertical wind generator of claim 23, wherein the blade produces enough horse power to rotate the shaft with sufficient hoarse power to force the generator to produce about 1 MW or more of power.

26. The vertical wind generator of claim 23, wherein the blade produces enough horse power to rotate the shaft with sufficient horse power to force the generator to produce about 1.5 MW or more of power.

27. The vertical wind generator of claim 23, wherein the generator is gearless.

28. The vertical wind generator of claim 23, further comprising a kinetic energy storage system.

29. The vertical wind generator of claim 23, further comprising a flushing member.

30. A method of building blades for a wind generator comprising:
providing a plurality of blade sections adapted for installation in a vertical axis wind turbine; and
assembling the blade sections to form a larger blade.

31. The method of claim 30, wherein providing comprises molding a plurality of blade sections from a composite material.

32. The method of claim 31, wherein the composite material comprises a light weight carbon fiber.

33. The method of claim 31, wherein the composite material comprises an epoxy composite.

34. The method of claim 31, wherein the composite material comprises reinforced plastic resonance system blocks.

35. The method of claim 31, wherein the step of molding comprises using a vacuum infused carbon fiber system.

36. The method of claim 31, wherein the step of molding comprises using a carbon black system.

37. The method of claim 31, wherein the blade sections are molded with interconnecting pins.

38. The method of claim 31, wherein the blade sections are molded with interconnecting channels.
